(19) United States
(12) Patent Application Publication
(10) Pub. No.: US 2016/0205042 A1
(43) Pub. Date: Jul. 14, 2016

(54) METHOD AND SYSTEM FOR TRANSCEIVING DATA OVER ON-CHIP NETWORK

(71) Applicants: SAMSUNG ELECTRONICS CO., LTD., Suwon-si (KR); Korea Advanced Institute of Science and Technology, Daejeon (KR)

(72) Inventors: Woong SEO, Hwaseong-si (KR); Minseok LEE, Daejeon (KR); Dongjun KIM, Daejeon (KR); Soojung RYU, Hwaseong-si (KR); Yeongon CHO, Hwaseong-si (KR)

(73) Assignees: SAMSUNG ELECTRONICS CO., LTD., Suwon-si (KR); Korea Advanced Institute of Science and Technology, Daejeon (KR)

(21) Appl. No.: 14/950,490

(22) Filed: Nov. 24, 2015

(30) Foreign Application Priority Data
Jan. 9, 2015 (KR) 10-2015-0003481

(51) Int. Cl. H04L 12/933; H04L 12/761

(52) U.S. Cl. CPC H04L 49/102; H04L 45/16

(57) ABSTRACT

A method of transceiving data over an on-chip network includes determining whether a packet is received by a first router among a plurality of first routers constituting a ring network; determining a transmission destination of the packet received by the first router; and transmitting the packet to a second router among a plurality of second routers constituting a bus network connected to the first router in response to the determined transmission destination being located on the bus network connected to the first router.

### CROSS-REFERENCE TO RELATED APPLICATION(S)

This application claims the benefit of Korean Patent Application No. 10-2015-0003481 filed on Jan. 9, 2015, in the Korean Intellectual Property Office, the entire disclosure of which is incorporated herein by reference for all purposes.

### BACKGROUND

1. Field

This application relates to a method and a system for transceiving data over an on-chip network.

2. Description of Related Art

A memory hierarchy greatly affects performance of a multi-core system. Particularly, since a last-level cache (LLC) connected to a core of a graphics processing unit (GPU) directly affects a data request for accessing a main memory, it is very important to select a capacity of the LLC and a structure of an on-chip network connected to the LLC.

Recently, as semiconductor integrated technology has advanced, an LLC capacity of 2 MB or greater may be used. With respect to the structure of the on-chip network connected to the LLC, a number of ports may be increased or a mesh network structure may be employed to solve a bottleneck problem that may occur in the related art. However, there is still a need for a solution to a bottleneck problem that may occur in data transmission.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a method of transceiving data over an on-chip network includes determining whether a packet is received by a first router among a plurality of first routers constituting a ring network; determining a transmission destination of the packet received by the first router; and transmitting the packet to a second router among a plurality of second routers constituting a bus network connected to the first router in response to the determined transmission destination being located on the bus network connected to the first router.

The method may further include transmitting the packet to another first router connected to the first among the plurality of first routers in response to the determined transmission destination being located on another bus network not connected to the first router.

The plurality of first routers may include a first transmission router and a first bypass router; and the method may further include, in response to the first router being the first transmission router, receiving at least one packet from at least one location selected from the group consisting of a second router connected to the first transmission router among the plurality of second routers, a cache connected to the first transmission router, and another first router connected to the first transmission router among the plurality of first routers; and, in response to the first router being the first bypass router, receiving at least one packet from at least one location selected from the group consisting of a cache connected to the first bypass router and another first router connected to the first bypass router among the plurality of first routers.

The transmitting of the packet may include transmitting a packet received from another router connected to the first router with priority in response to the first router receiving respective packets from the router connected to the first router and a cache connected to the first router.

The method may further include acquiring the packet in the second router in response to the transmission destination of the received packet being the second router; and transmitting the packet from the second router to another second router on the bus network in response to the transmission destination of the received packet being the other second router.

The ring network may be a network configured to transmit a packet in a single direction.

The plurality of first routers may be connected to each other by a plurality of channels.

The plurality of first routers may be connected to each other by a first channel configured to transmit the packet to the second router in a first direction and a second channel configured to transmit the packet to the second router in a second direction opposite to the first direction.

The transmitting of the packet may include selecting either the first channel or the second channel to transmit the packet to the second router based on a distance between the determined transmission destination and the first router.

In another general aspect, a system configured to transceive data over an on-chip network includes a packet detector configured to determine whether a packet is received by a first router among a plurality of first routers constituting a ring network; a transmission destination identifier configured to determine a transmission destination of the packet received by the first router; and a packet transceiver configured to transmit the packet to a second router among a plurality of second routers constituting a bus network connected to the first router in response to the determined transmission destination being located on the bus network connected to the first router.

The packet transceiver may be further configured to transmit the packet to another first router connected to the first router among the plurality of first routers in response to the determined transmission destination being located on another bus network that is not connected to the first router.

The plurality of first routers may include a first transmission router and a first bypass router; and the packet transceiver may be further configured to, in response to the first router being the first transmission router, receive at least one packet from at least one location selected from the group consisting of a second router connected to the first transmission router among the plurality of second routers, a cache connected to the first transmission router, and another first router connected to the first transmission router among the plurality of first routers; and, in response to the first router being the first bypass router, receive at least one packet from at least one location selected from the group consisting of a cache connected to the first bypass router and another first router connected to the first bypass router among the plurality of first routers.

The packet transceiver may be further configured to transmit a packet received from another router connected to the first router with priority in response to the first router receiving respective packets from the router connected to the first router and a cache connected to the first route.

The second router may be configured to acquire the packet in response to the transmission destination of the received packet being the second router, and transmit the packet to another second router on the bus network in response to the transmission destination of the received packet being the other second router.

In another general aspect, a system for transceiving data over an on-chip network includes a plurality of first routers constituting a ring network; a plurality of caches respectively connected to the plurality of first routers; a plurality of second routers constituting at least one bus network connected to the ring network; and a plurality of cores configured to transceive a packet with the plurality of second routers.

The plurality of first routers may include a first transmission router and a first bypass router; the first transmission router may be configured to receive at least one packet from at least one location selected from the group consisting of a second router connected to the first transmission router among the plurality of second routers, a cache connected to the first transmission router among the plurality of caches, and a first router connected to the first transmission router among the plurality of first routers; and the first bypass router may be configured to receive at least one packet from location selected from the group consisting of a cache connected to the first bypass router among the plurality of caches, and a first router connected to the first bypass router among the plurality of first routers.

The system may further include at least one channel configured to transceive a packet between the plurality of first routers.

The at least one channel may include a unidirectional channel configured to transmit a packet in one direction.

The at least one channel may include a bidirectional channel configured to transmit a packet in a first direction or a second direction opposite to the first direction.

Other features and aspects will be apparent from the following detailed description, the drawings, and the claims.

### BRIEF DESCRIPTION OF THE DRAWINGS

FIG. 1 illustrates a flowchart of an example of a method of transceiving data over an on-chip network.

FIG. 2 illustrates a detailed flowchart for explaining an example of a method of transmitting data over an on-chip network.

FIG. 3 illustrates a diagram for explaining an example of a routing system in which four bus networks are connected to a ring network.

FIG. 4 illustrates a diagram for explaining an example of a routing system in which two bus networks are connected to a ring network.

FIG. 5 illustrates a flowchart of an example of another method of transceiving data over an on-chip network.

FIG. 6 illustrates a diagram for explaining an example of a routing system in which four bus networks are connected to a ring network.

FIG. 7 illustrates a diagram for explaining an example of a routing system in which four bus networks are connected to a ring network.

FIG. 8 illustrates a block diagram of an example of a routing system.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent to one of ordinary skill in the art. The sequences of operations described herein are merely examples, and are not limited to those set forth herein, but may be changed as will be apparent to one of ordinary skill in the art, with the exception of operations necessarily occurring in a certain order. Also, descriptions of functions and constructions that are well known to one of ordinary skill in the art may be omitted for increased clarity and conciseness.

The features described herein may be embodied in different forms, and are not to be construed as being limited to the examples described herein. Rather, the examples described herein have been provided so that this disclosure will be thorough and complete, and will convey the full scope of the disclosure to one of ordinary skill in the art.

When an element is referred to as being “connected to” or “coupled to” another element, it may be “directly connected” or “directly coupled” to the other element, or “electrically connected to” the other element, with intervening elements therebetween. The terms “comprises,” “comprising,” “includes,” and “including” specify the presence of elements, but do not preclude the presence or addition of one or more other elements, unless otherwise specified.

Hereinafter, examples will be described in detail with reference to the accompanying drawings.

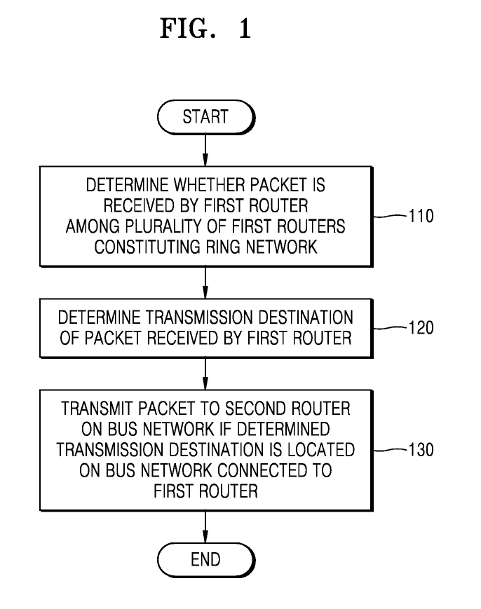

FIG. 1 illustrates a flowchart of an example of a method of transceiving data over an on-chip network.

In operation 110, a system for transceiving data over an on-chip network (hereinafter referred to as a routing system) determines whether a packet is received by a first router among a plurality of first routers constituting a ring network.

The ring network is a type of network topology. Each first router of the ring network is connected respectively to other first routers on both sides of the first router, and thus the first routers form continuous channels in the form of a ring to perform communication. Data is transferred via a channel between a first router and another first router. In the description herein, data is transferred in units of packets via a channel between a first router and another first router.

A first router is connected to a last-level cache (LLC, hereinafter, referred to as a cache). The cache is connected to a memory controller and a dynamic random access memory (DRAM). A width of a channel between a first router and another first router is set in consideration of a size of a cache line of a cache and a size of routing information. In detail, a width of a channel is set so that a packet including data read from a cache and routing information may be transmitted to a first router as one flit. A flit refers to a minimum unit in which data is transceived over an on-chip network.

In one example, a first router may be either a first transmission router or a first bypass router. The first transmission router is a first router connected to a bus network to be described later. The first bypass router is a first router that is not connected to the bus network among the plurality of first routers constituting the ring network. The bus network is constituted by a plurality of second routers. The bus network is described with reference to operation 130 in detail.

The first transmission router receives a packet from at least one location selected from the group consisting of a second router connected to the first transmission router, a cache connected to the first transmission router, and another first router connected to the first transmission router. The other first router connected to the first transmission router may be a first transmission router or a first bypass router depending on a structure of the bus network connected to the ring network.

The first bypass router receives a packet from at least one location selected from the group consisting of a cache connected to the first bypass router and another first router connected to the first bypass router. The other first router connected to the first bypass router may be a first transmission router or a first bypass router depending a structure of the bus network connected to the ring network.

In operation 120, the routing system determines a transmission destination of the packet received by the first router.

The first router identifies the transmission destination of the packet from routing information included in the received packet. The transmission destination of the packet may be indicated as an address of a core connected to a second router, or an address of the second router.

In operation 130, if the determined transmission destination is located on the bus network connected to the first router, the routing system transmits the packet to a second router among a plurality of second routers constituting the bus network.

In the routing system, the first router is connected to other first routers and the bus network. The first router connected to the bus network is referred to as a first transmission router. The first transmission router checks whether the determined transmission destination corresponds to a second router located on the bus network connected to the first transmission router. The transmission destination may be indicated as an address of a core connected to the second router, or an address of the second router.

If the transmission destination is located on the bus network connected to the first transmission router, the first transmission router transmits the packet to the second router connected to the first transmission router among the plurality of second routers constituting the bus network so that the packet is transmitted to the transmission destination.

If the transmission destination is not located on the bus network connected to the first transmission router, the first transmission router transmits the packet to another first router connected to the first transmission router. The first transmission router is connected to other first routers in both directions. The first transmission router transmits the packet to a first router that is connected to the first transmission router in one of the both directions according to a predetermined direction in the ring network.

Additionally, in the routing system, the first router may not be connected to the bus network, but may be connected only to other first routers. A first router that is not connected to the bus network is referred to as a first bypass router. The first bypass router is connected to other first routers in both directions. The first transmission router transmits the packet to a first router that is connected to the first transmission router in one of the both directions according to a predetermined direction in the ring network.

A packet transmitted by the second router on a bus network is transferred via a channel connecting a plurality of second routers to each other. If an address of the second router or an address of a core connected to the second router corresponds to the transmission destination of the packet, the second router acquires the packet. If an address of the second router or an address of the core connected to the second router does not correspond to the transmission destination of the packet, the second router transmits the packet to another second router via the channel.

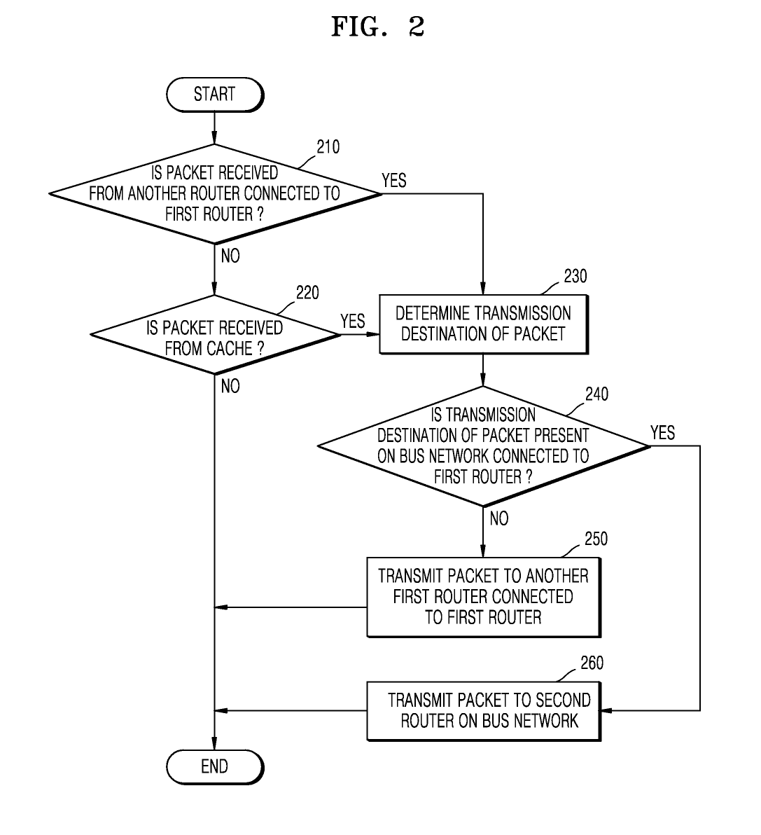

FIG. 2 illustrates a detailed flowchart for explaining an example of a method of transmitting data over an on-chip network.

The flowchart shown in FIG. 2 describes an operation of a first router among a plurality of first routers constituting a ring network included in a routing system.

In operation 210, the first router determines whether the first router has received a packet from another router connected to the first router.

In one example, the first router may be either a first transmission router or a first bypass router. The first transmission router may receive the packet from another first router connected to the first transmission router in a predetermined direction of a ring network. For example, if the ring network operates in a clockwise direction, the first transmission router may receive the packet from another first router located before and connected to the first transmission router with reference to the clockwise direction.

Additionally, the first transmission router may receive a packet from a second router of a bus network connected to the first transmission router. A plurality of second routers constituting the bus network are respectively connected to a plurality of cores. The second router may transmit a packet obtained from the core to which the second router is connected to the first transmission router connected to the bus network via the bus network.

The first bypass router may receive a packet from another first router connected to the first bypass in a predetermined direction of a ring network. For example, if the ring network operates in a clockwise direction, the first bypass router may receive a packet from another first router located before and connected to the first bypass router with reference to the clockwise direction.

In operation 220, the first router determines whether the first router has received a packet from a cache connected to the first router.

The cache is connected to a memory controller. Additionally, the memory controller is connected to a DRAM, and thus transmits data received from the DRAM to the cache.

The first router may receive a packet including data read from the cache and routing information.

In operation 230, the first router determines a transmission destination of the received packet.

In one example, the first router extracts information about the transmission destination to which the packet is to be transmitted from the routing information included in the packet.

In operation 240, the first router determines whether the determined transmission destination of the packet is present on the bus network connected to the first router. The first router includes information about addresses of a plurality of second routers constituting the bus network. The first router determines whether the transmission destination corresponds to a second router among the plurality of second routers constituting the bus network connected to the first router.

In operation 250, the first router transmits the packet to another first router connected to the first router in a predetermined transmission direction in the ring network.

If a result of the determining in operation 240 is that the transmission destination of the packet is not present on the bus network connected to the first router, the first router transmits the packet to another router connected to the first router in operation 250.

For example, if the predetermined transmission direction is a clockwise direction, the first router transmits the packet to another first router that is connected to the first router in a clockwise direction.

The first router may receive respective packets from another router and a cache connected to the first router. If the first router receives the respective packets from the other router and the cache connected to the first router, the packet received from the other router connected to the first router may be transmitted to the first router with priority.

In operation 260, the first router transmits the packet to a second router on a bus network.

If a result of the determining in operation 240 is that a transmission destination of the packet is present on the bus network connected to the first router, the first router transmits the packet to a second router connected to the first router among a plurality of second routers constituting the bus network connected to the first router.

If an address of the second router or an address of a core connected to the second router corresponds to the transmission destination of the packet, the second router acquires the packet. If an address of the second router or an address of a core connected to the second router does not correspond to the transmission destination of the packet, the second router transmits the packet to another second router via a channel.

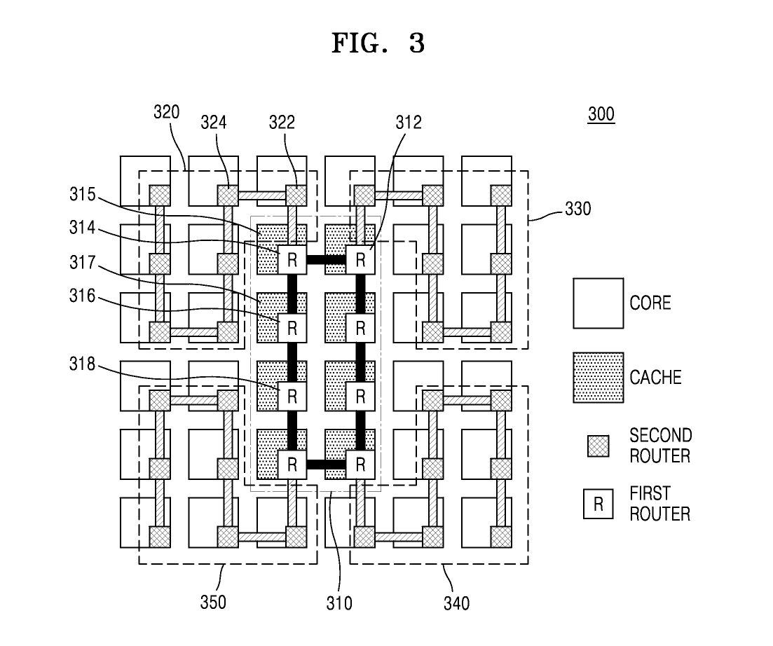

FIG. 3 illustrates a diagram for explaining an example of a routing system 300 in which four bus networks 320, 330, 340, and 350 are connected to a ring network 310.

The ring network 310 is constituted by a plurality of first routers including first routers 312, 314, 316, and 318, which include a first transmission router 314 and first bypass routers 312, 316, and 318. The bus networks 320, 330, 340, and 350 are each constituted by a plurality of second routers, which include second routers 322 and 324 on the bus network 320.

The ring network 310 is a unidirectional network via which a packet is transmitted in a predetermined direction. In the following description, a transmission direction in the ring network 310 is described as being counterclockwise.

The first transmission router 314 may receive a packet from the first bypass router 312 in the counterclockwise direction. Additionally, the first transmission router 314 may receive a packet from the second router 322 connected to a first router. Additionally, the first transmission router 314 may receive a packet from a cache 315 connected to the first transmission router 314.

If the first transmission router 314 receives a packet, the first transmission router 314 determines a transmission destination of the packet. For example, the first transmission router 314 determines a transmission destination of the packet from routing information included in the packet. If the first transmission router 314 receives a plurality of packets, the first transmission router 314 may transmit a packet received from another router 312 or 322 with priority over a packet received from the cache 315. If the first transmission router receives respective packets from the first bypass router 312 connected to the first transmission router 314 and the second router 322, the first transmission router 314 may randomly transmit either of the packets first. However, this is only an example. Depending on a setting of the routing system 300, the first transmission router 314 may transmit a packet received from the first bypass router 312 with priority over a packet received from the second router 322. In another example, the first transmission router 314 may transmit a packet received from the second router 322 with priority over a packet received from the first bypass router 312.

If the transmission destination of the packet is present on the bus network 320 connected to the first transmission router 314, the first transmission router 314 transmits the packet to the second router 322 connected to the first transmission router 314. If the transmission destination of the packet is present on a bus network that is not connected to the first transmission router 314 (for example, the bus network 330), the first transmission router 314 transmits the packet to the first bypass router 316 connected to the first transmission router 314.

After the second router 322 has received the packet, the second router 322 determines whether the transmission destination of the packet corresponds to the second router 322. If the transmission destination of the packet corresponds to the second router 322, the second router 322 acquires the packet. In another example, if the transmission destination of the packet does not correspond to the second router 322, the second router 322 transmits the packet to a second router 324 connected to the second router 322.

In another example, the first bypass router 316 may receive a packet from a cache 317 connected to the first bypass router 316. Additionally, the first bypass router 316 may receive a packet from the first transmission router 314 connected to the first bypass router 316.

The first bypass router 316 determines the transmission destination of the packet from routing information included in the received packet. The first bypass router 316 transmits the packet to the first bypass router 318 in a predetermined counterclockwise direction with respect to the ring network 310.

If the first bypass router 316 receives respective packets from the cache 317 connected to the first bypass router 316 and the first transmission router 314, the first bypass router 316 may transmit the packet received from the first transmission router 314 with priority over the packet received from the cache 317.

The method described with reference to FIG. 3 may be also applied to the other bus networks 330, 340, and 350 and the other first routers that are connected to the ring network 310 shown in FIG. 3.

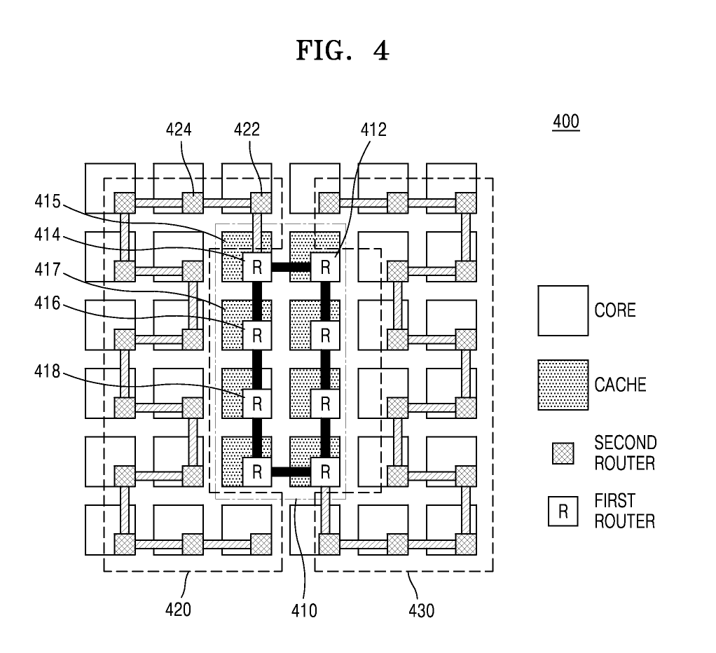

FIG. 4 illustrates a diagram for explaining an example of a routing system 400 in which two bus networks 420 and 430 are connected to a ring network 410.

The ring network 410 is constituted by a plurality of first routers including first routers 412, 414, 416, and 418, which include a first transmission router 414 and first bypass routers 412, 416, and 418. The bus networks 420 and 430 are each constituted by a plurality of second routers, which include second routers 422 and 424 on the bus network 420.

The ring network 410 is a unidirectional network via which a packet is transmitted in a predetermined direction. In the following description of FIG. 4, a transmission direction in the ring network 410 is a counterclockwise direction.

The first transmission router 414 may receive a packet from the first bypass router 412 in the counterclockwise direction. Additionally, the first transmission router 414 may receive a packet from the second router 422 connected to a first router. Additionally, the first transmission router 414 may receive a packet from a cache 415 connected to the first transmission router 414.

If the first transmission router 414 receives a packet, the first transmission router 414 determines a transmission destination of the packet. For example, the first transmission router 414 determines a transmission destination of the packet from routing information included in the packet. If the first transmission router 414 receives a plurality of packets, the first transmission router 414 may transmit a packet received from another router 412 or 422 to another router with priority over a packet received from the cache 415. If the first transmission router 414 receives respective packets from the first bypass router 412 connected to the first transmission router 414 and the second router 422, the first transmission router 414 may randomly transmit either of the packets first. However, this is only an example. Depending on a setting of the routing system 400, the first transmission router 414 may transmit a packet received from the first bypass router 412 with priority over a packet received from the second router 422. In another example, the first transmission router 414 may transmit a packet received from the second router 422 with priority over a packet received from the first bypass router 412.

If the transmission destination of the packet is present on the bus network 420 connected to the first transmission router 414, the first transmission router 414 transmits the packet to the second router 422 connected to the first transmission router 414. If the transmission destination of the packet is present on a bus network that is not connected to the first transmission router 414 (for example, the bus network 430), the first transmission router 414 transmits the packet to the first bypass router 416 connected to the first transmission router 414.

After the second router 422 has received the packet, the second router 422 determines whether the transmission destination of the packet corresponds to the second router 422. If the transmission destination of the packet corresponds to the second router 422, the second router 422 acquires the packet. In another example, if the transmission destination of the packet does not correspond to the second router 422, the second router 422 transmits the packet to a second router 424 connected to the second router 422.

In another example, the first bypass router 416 may receive a packet from a cache 417 connected to the first bypass router 416. Additionally, the first bypass router 416 may receive a packet from the first transmission router 414 connected to the first bypass router 416.

The first bypass router 416 determines the transmission destination of the packet from routing information included in the received packet. The first bypass router 416 transmits the packet to the first bypass router 418 in a predetermined counterclockwise direction with respect to the ring network 410.

If the first bypass router 416 receives respective packets from the cache 417 connected to the first bypass router 416 and the first transmission router 414, the first bypass router 416 may transmit the packet received from the first transmission router 414 with priority over the packet received from the cache 417.

The method described with reference to FIG. 4 may be also applied to the other bus network 430 and the other first routers that are connected to the ring network 410 shown in FIG. 4.

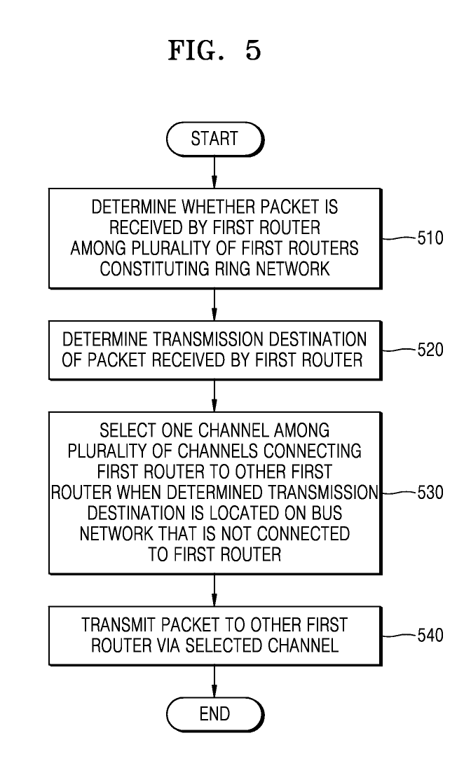

FIG. 5 illustrates a flowchart for explaining an example of another method of transceiving data over an on-chip network.

In operation 510, a routing system determines whether a packet is received by a first router among a plurality of first routers constituting a ring network.

In one example, the first router may be either a first transmission router or a first bypass router.

The first transmission router receives a packet from at least one location selected from the group consisting of a second router connected to the first transmission router, a cache connected to the first transmission router, and another first router connected to the first transmission router. The first bypass router receives a packet from at least one location selected from the group consisting of a cache connected to the first bypass router and another first router connected to the first bypass router.

Operation 510 corresponds to operation 110 described with reference to FIG. 1.

In operation 520, the routing system determines a transmission destination of the packet received by the first router. The first router identifies the transmission destination of the packet from routing information included in the received packet.

Operation 520 corresponds to operation 120 described with reference to FIG. 1.

In operation 530, if the determined transmission destination is located on a bus network that is not connected to the first router, the routing system selects one of a plurality of channels connecting a first router to other first routers.

In one example, in a routing system, a plurality of first routers constituting a ring network are connected to each other by a plurality of channels. For example, the plurality of first routers are connected to each other by two channels. The plurality of channels transmit a packet in a predetermined direction with respect to the ring network. In another example, the plurality of channels transmit a packet in opposite directions relative to each other. For example, the plurality of channels include both a channel via which a packet is transmitted in a first direction and a channel via which a packet is transmitted in a second direction different from the first direction. In this example, a first router may transmit a packet to another first router on a first side of the first router via a first channel in the first direction, and receive a packet from the other first router on the first side of the first router via a second channel in the second direction. Also, the first router may transmit a packet to another first router on a second side of the first router via the second channel in the second direction, and receive a packet from the other first router on the second side of the first router via the first channel in the first direction.

The routing system may select one of the plurality of channels at random. In another example, if the plurality of channels transmit a packet in opposite directions relative to each other, the routing system selects a channel based on a distance between the first router and the transmission destination of the packet received by the first router. The routing system may select a channel that transmits in a direction in which the packet may be transmitted a shortest distance to the transmission destination.

In operation 540, the routing system transmits the packet to another first router via the selected channel.

For example, if all the plurality of channels are channels for transmitting the packet in a clockwise direction, the routing system transmits the packet to a router in a next position in a clockwise direction via the selected channel. Additionally, if a channel among the plurality of channels transmits a packet in a clockwise direction and another channel among the plurality of channels transmits a packet in a counterclockwise direction, the routing system transmits a packet to a first router in a next position in the direction of the selected channel.

The method of transceiving a packet between first routers via a ring network is described with reference to the flowchart shown in FIG. 5. The method of transmitting a packet from a first router to a second router is the same as the method described with reference to the flowchart shown in FIG. 1.

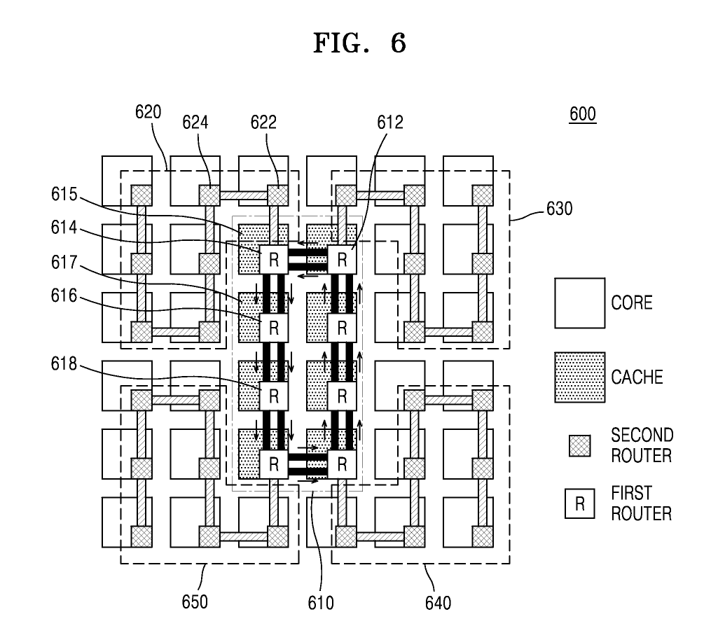

FIG. 6 illustrates a diagram for explaining an example of a routing system 600 in which four bus networks 620, 630, 640, and 650 are connected to a ring network 610.

Referring FIG. 6, a case when a transmission destination of a packet received by a first router (for example, a first transmission router 614) is located on a bus network that is not connected to the first router (for example, the bus network 630) is described.

The ring network 610 is constituted by a plurality of first routers including first routers 612, 614, 616, and 618, which include the first transmission router 614 and first bypass routers 612, 616, and 618. The bus networks 620, 630, 640, and 650 are each constituted by a plurality of second routers, which include second routers 622 and 624 on the bus network 620.

The ring network 610 is a unidirectional network via which a packet is transmitted in a predetermined direction. In the example in FIG. 6, a transmission direction in the ring network 610 is a counterclockwise direction.

The first transmission router 614 may receive a packet from the first bypass router 612 in the counterclockwise direction. Additionally, the first transmission router 614 may receive a packet from the second router 622 connected to the first router. Additionally, the first transmission router 614 may receive a packet from a cache 615 connected to the first transmission router 614.

If the first transmission router 614 receives a packet, the first transmission router 614 determines a transmission destination of the packet. If the first transmission router 614 receives a plurality of packets, the first transmission router 614 may transmit a packet received from another router 622 or 612 with priority as described with reference to FIG. 3.

If the transmission destination is located on a bus network that is not connected to the first transmission router 614 (for example, the bus network 630), the first transmission router 614 transmits the packet to the first bypass router 616 connected to the first transmission router 614.

The first transmission router 614 selects one of two channels connecting the first transmission router 614 to the first bypass router 616. For example, the first transmission router 614 may select one of the two channels at random. In another example, the first transmission router 614 may select a left channel among the two channels according to a preset rule, and transmit the packet to the first bypass router 616 via the left channel.

In another example, the first bypass router 616 may receive a packet from a cache 617 connected to the first bypass router 616. Additionally, the first bypass router 616 may also receive a packet from the first transmission router 614 connected to the first bypass router 616.

The first bypass router 616 determines a transmission destination of the packet from routing information included in the received packet. The first bypass router 616 transmits the packet to another first bypass router 618 in a predetermined counterclockwise direction with respect to the ring network 610.

If the first bypass router 616 receives respective packets from the cache 617 connected to the first bypass router 616 and the first transmission router 614, the first bypass router 616 may transmit the packet received from the first transmission router 614 to another router with priority over the packet received from the cache 617.

The first bypass router 616 selects one of two channels connecting the first transmission router 614 to another first bypass router 618. For example, the first transmission router 614 may select one of the two channels at random. In another example, the first transmission router 614 may select a left channel among the two channels according to a preset rule, and transmit the packet to the first bypass router 616 via the left channel.

The method described with reference to FIG. 6 may be also applied to the other bus networks 630, 640, and 650 and the other first routers that are connected to the ring network 610 shown in FIG. 6.

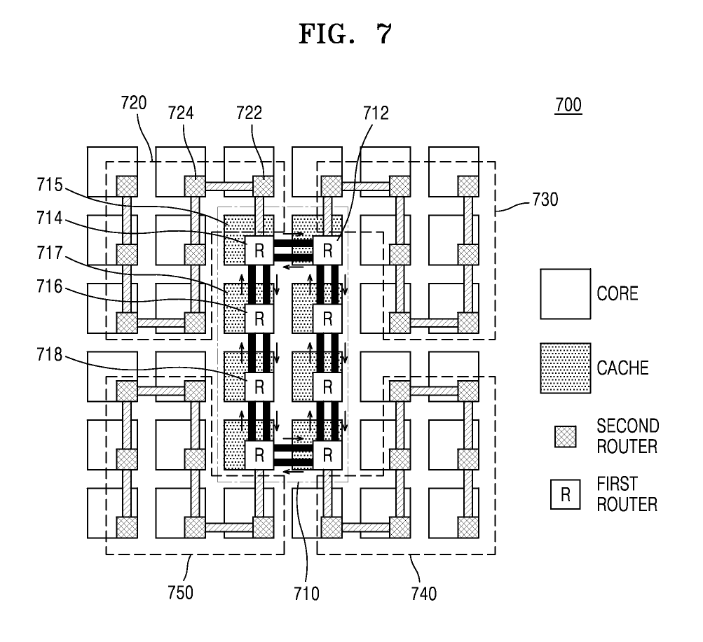

FIG. 7 illustrates a diagram for explaining an example of a routing system 700 in which four bus networks 720, 730, 740, and 750 are connected to a ring network 710.

Referring to FIG. 7, a case when a transmission destination of a packet received by a first router (for example, a first transmission router 714) is located on a bus network that is not connected to the first router (for example, the bus network 730) is described.

The ring network 710 is constituted by a plurality of first routers including first routers 712, 714, 716, and 718, which include the first transmission router 714 and first bypass routers 712, 716, and 718. The bus networks 720, 730, 740, and 750 are each constituted by a plurality of second routers, which include second routers 722 and 724 on the bus network 720.

Referring to FIG. 7, the first routers, including the plurality of first routers 712, 714, 716, and 718, are connected to each other by a plurality of channels via which a packet is transmitted in opposite directions relative to each other.

The first transmission router 714 may receive a packet from the first bypass router 712. Additionally, the first transmission router 714 may receive a packet from the second router 722 connected to a first router. Additionally, the first transmission router 714 may receive a packet from a cache 715 connected to the first transmission router 714.

When the first transmission router 714 receives a packet, the first transmission router 714 determines a transmission destination of the packet. If the first transmission router 714 receives a plurality of packets, the first transmission router 714 may transmit a packet received from another router 722 or 712 with priority as described with reference to FIG. 3.

Since the transmission destination of the packet is located on a bus network that is not connected to the first transmission router 714 (for example, the bus network 730), the first transmission router 714 transmits the packet to the first bypass router 712 or another first bypass router 716 connected to the first transmission router 414.

In one example, the first transmission router 714 selects a channel among the plurality of channels based on a distance between the transmission destination of the packet and the first transmission router 714. The first transmission router 714 selects a channel that is in a direction in which the packet may be transmitted by a shortest distance to the transmission destination. For example, if a transmission destination of the packet is the second bus network 730, the first transmission router 714 selects a channel via which a packet is transmitted in a clockwise direction. In another example, if a transmission destination of the packet is a fourth bus network 750, the first transmission router 714 selects a channel via which a packet is transmitted in a counterclockwise direction. If channels transmitting a packet in opposite directions are to be employed, and a distance from the first transmission router 714 to the transmission destination is the same in all of the channels, one of the channels may be selected at random.

However, the examples described above are only examples, and the first transmission router 714 may select a channel at random.

The method described with reference to FIG. 7 may be also applied to the other bus networks 730, 740, and 750 and the other first routers that are connected to the ring network 710 shown in FIG. 7.

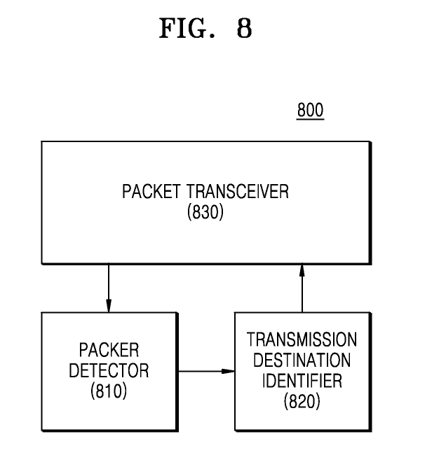

FIG. 8 illustrates a block diagram of an example of a routing system 800.

The routing system 800 shown in FIG. 8 includes only elements related to the current example. Accordingly, it will be understood by one of ordinary skill in the art that in addition to the elements shown in FIG. 8, the routing system 800 may also include other general-use elements.

In one example, the routing system 800 is located on a first router.

A packet detector 810 determines whether a first router among a plurality of first routers constituting a ring network has received a packet.

The first router may be either a first transmission router or a first bypass router.

In a case that the first router is the first transmission router, the packet detector 810 determines whether a packet transceiver 830 has received a packet from at least one location selected from the group consisting of a second router connected to the first transmission router, a cache connected to the first transmission router, and another first router connected to the first transmission router among the plurality of first routers. The second router is one of a plurality of second routers constituting a bus network connected to ring network at the first router. The other first router connected to the first transmission router may be another first transmission router or a first bypass router depending a structure of the bus network connected to the ring network.

In a case that the first router is the first bypass router, the packet detector 810 determines whether the packet transceiver 830 has received a packet from at least one location selected from the group consisting of a cache connected to the first bypass router and another first router connected to the first bypass router among the plurality of first routers. The other first router connected to the first bypass router may be a first transmission router or another first bypass router depending on a structure of the bus network connected to the ring network.

The transmission destination identifier 820 determines a transmission destination of the packet received by the packet transceiver 830.

The transmission destination identifier 820 identifies the transmission destination of the received packet from routing information included in the packet. The transmission destination of the packet may be indicated as an address of a core connected to the second router, or an address of the second router.

If the determined transmission destination is located on the bus network connected to the first router, the packet transceiver 830 transmits the packet to the second router connected to the first router among the plurality of second routers constituting the bus network.

The packet transceiver 830 determines whether the determined transmission destination corresponds to a second router located on the bus network connected to the first router. The transmission destination may be indicated as an address of a core connected to the second router, or an address of the second router.

If the transmission destination of the packet is located on the bus network connected to the first router, the packet transceiver 830 transmits the packet to the second router connected to the first router among the plurality of second routers constituting the bus network so that the packet is transmitted to the transmission destination.

If the transmission destination of the packet is not located on the bus network connected to the first router, the packet transceiver 830 transmits the packet to another first router connected to the first router. The packet transceiver 830 is connected to other first routers in both directions. The packet transceiver 830 transmits a packet to another first router connected in one of the both directions in the ring network.

In another example, if first routers constituting a ring network are connected by a plurality of channels, the packet transceiver 830 selects a channel among the plurality of channels connecting a first router to another first router.

For example, the packet transceiver 830 may select one channel at random among two channels respectively connecting different first routers to each other. The packet transceiver 830 transmits a packet via the selected channel. The plurality of channels may transmit a packet in a same direction, or transmit a packet in opposite directions relative to each other.

If the plurality of channels transmit a packet in opposite directions relative to each other, the packet transceiver 830 may select a channel based on a distance between a transmission destination of the received packet and the first router. The packet transceiver 830 may select a channel that transmits a packet in a direction in which the packet may be transmitted in a shortest distance to the transmission destination.

The first routers and the second routers in FIGS. 3, 4, 7, and 8 and the packet detector 810, the transmission destination identifier 820, and the packet transceiver in FIG. 8 that perform the operations described herein with respect to FIGS. 1-8 are implemented by hardware components. Examples of hardware components include controllers, generators, drivers, memories, comparators, arithmetic logic units, adders, multipliers, line drivers, and any other electronic components known to one of ordinary skill in the art. In one example, the hardware components are implemented by computing hardware, for example, by one or more processors or computers. A processor or computer is implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices known to one of ordinary skill in the art that is capable of responding to and executing instructions in a defined manner to achieve a desired result. In one example, a processor or computer includes, or is connected to, one or more memories storing instructions or software that are executed by the processor or computer. Hardware components implemented by a processor or computer execute instructions or software, such as an operating system (OS) and one or more software applications that run on the OS, to perform the operations described herein with respect to FIGS. 1-8. The hardware components also access, manipulate, process, create, and store data in response to execution of the instructions or software. For simplicity, the singular term “processor” or “computer” may be used in the description of the examples described herein, but in other examples multiple processors or computers are used, or a processor or computer includes multiple processing elements, or multiple types of processing elements, or both. In one example, a hardware component includes multiple processors, and in another example, a hardware component includes a processor and a controller. A hardware component has any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1, 2, and 5 that perform the operations described herein with respect to FIGS. 1-8 are performed by a processor or a computer as described above executing instructions or software to perform the operations described herein.

Instructions or software to control a processor or computer to implement the hardware components and perform the methods as described above are written as computer programs, code segments, instructions or any combination thereof, for individually or collectively instructing or configuring the processor or computer to operate as a machine or special-purpose computer to perform the operations performed by the hardware components and the methods as described above. In one example, the instructions or software include machine code that is directly executed by the processor or computer, such as machine code produced by a compiler. In another example, the instructions or software include higher-level code that is executed by the processor or computer using an interpreter. Programmers of ordinary skill in the art can readily write the instructions or software based on the block diagrams and the flow charts illustrated in the drawings and the corresponding descriptions in the specification, which disclose algorithms for performing the operations performed by the hardware components and the methods as described above.

The instructions or software to control a processor or computer to implement the hardware components and perform the methods as described above, and any associated data, data files, and data structures, are recorded, stored, or fixed in or on one or more non-transitory computer-readable storage media. Examples of a non-transitory computer-readable storage medium include read-only memory (ROM), random-access memory (RAM), flash memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, magnetic tapes, floppy disks, magneto-optical data storage devices, optical data storage devices, hard disks, solid-state disks, and any device known to one of ordinary skill in the art that is capable of storing the instructions or software and any associated data, data files, and data structures in a non-transitory manner and providing the instructions or software and any associated data, data files, and data structures to a processor or computer so that the processor or computer can execute the instructions. In one example, the instructions or software and any associated data, data files, and data structures are distributed over network-coupled computer systems so that the instructions and software and any associated data, data files, and data structures are stored, accessed, and executed in a distributed fashion by the processor or computer.

The particular implementations shown and described herein are merely examples, and are not intended to limit the scope of the disclosure and claims in any way. For the sake of brevity, conventional electronics, control systems, and other functional aspects of the systems, and components of the individual operating components of the systems, may not be described in detail. Furthermore, the connecting lines or connectors shown in the figures are intended to represent examples of functional relationships, physical connections, and logical connections between the various elements. Many alternative or additional functional relationships, physical connections, and logical connections may be present in a practical device. Moreover, no item or component is essential to the practice of any of the examples or any implementation covered by the claims unless the item or component is specifically described as “essential” or “critical.”

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A method of transceiving data over an on-chip network, the method comprising:
determining whether a packet is received by a first router among a plurality of first routers constituting a ring network;
determining a transmission destination of the packet received by the first router; and
transmitting the packet to a second router among a plurality of second routers constituting a bus network connected to the first router in response to the determined transmission destination being located on the bus network connected to the first router.

2. The method of claim 1, further comprising transmitting the packet to another first router connected to the first among the plurality of first routers in response to the determined transmission destination being located on another bus network not connected to the first router.

3. The method of claim 1, wherein the plurality of first routers comprise a first transmission router and a first bypass router; and
the method further comprises:
in response to the first router being the first transmission router, receiving at least one packet from at least one location selected from the group consisting of a second router connected to the first transmission router among the plurality of second routers, a cache connected to the first transmission router, and another first router connected to the first transmission router among the plurality of first routers; and
in response to the first router being the first bypass router, receiving at least one packet from at least one location selected from the group consisting of a cache connected to the first bypass router and another first router connected to the first bypass router among the plurality of first routers.

4. The method of claim 1, wherein the transmitting of the packet comprises transmitting a packet received from another router connected to the first router with priority in response to the first router receiving respective packets from the router connected to the first router and a cache connected to the first router.

5. The method of claim 1, further comprising:
acquiring the packet in the second router in response to the transmission destination of the received packet being the second router; and
transmitting the packet from the second router to another second router on the bus network in response to the transmission destination of the received packet being the other second router.

6. The method of claim 1, wherein the ring network is a network configured to transmit a packet in a single direction.

7. The method of claim 6, wherein the plurality of first routers are connected to each other by a plurality of channels.

8. The method of claim 1, wherein the plurality of first routers are connected to each other by a first channel configured to transmit the packet to the second router in a first direction and a second channel configured to transmit the packet to the second router in a second direction opposite to the first direction.

9. The method of claim 8, wherein the transmitting of the packet comprises selecting either the first channel or the second channel to transmit the packet to the second router based on a distance between the determined transmission destination and the first router.

10. A system configured to transceive data over an on-chip network, the system comprising:
a packet detector configured to determine whether a packet is received by a first router among a plurality of first routers constituting a ring network;
a transmission destination identifier configured to determine a transmission destination of the packet received by the first router; and
a packet transceiver configured to transmit the packet to a second router among a plurality of second routers constituting a bus network connected to the first router in response to the determined transmission destination being located on the bus network connected to the first router.

11. The system of claim 10, wherein the packet transceiver is further configured to transmit the packet to another first router connected to the first router among the plurality of first routers in response to the determined transmission destination being located on another bus network that is not connected to the first router.

12. The system of claim 10, wherein the plurality of first routers comprise a first transmission router and a first bypass router; and
the packet transceiver is further configured to:
in response to the first router being the first transmission router, receive at least one packet from at least one location selected from the group consisting of a second router connected to the first transmission router among the plurality of second routers, a cache connected to the first transmission router, and another first router connected to the first transmission router among the plurality of first routers; and
in response to the first router being the first bypass router, receive at least one packet from at least one location selected from the group consisting of a cache connected to the first bypass router and another first router connected to the first bypass router among the plurality of first routers.

13. The system of claim 10, wherein the packet transceiver is further configured to transmit a packet received from another router connected to the first router with priority in response to the first router receiving respective packets from the router connected to the first router and a cache connected to the first route.

14. The system of claim 10, wherein the second router is configured to acquire the packet in response to the transmission destination of the received packet being the second router, and transmit the packet to another second router on the bus network in response to the transmission destination of the received packet being the other second router.

15. A system for transceiving data over an on-chip network, the system comprising:
a plurality of first routers constituting a ring network;
a plurality of caches respectively connected to the plurality of first routers;
a plurality of second routers constituting at least one bus network connected to the ring network; and
a plurality of cores configured to transceive a packet with the plurality of second routers.

16. The system of claim 15, wherein the plurality of first routers comprise a first transmission router and a first bypass router;
the first transmission router is configured to receive at least one packet from at least one location selected from the group consisting of a second router connected to the first transmission router among the plurality of second routers, a cache connected to the first transmission router among the plurality of caches, and a first router connected to the first transmission router among the plurality of first routers; and
the first bypass router is configured to receive at least one packet from location selected from the group consisting of a cache connected to the first bypass router among the plurality of caches, and a first router connected to the first bypass router among the plurality of first routers.

17. The system of claim 15, further comprising at least one channel configured to transceive a packet between the plurality of first routers.

18. The system of claim 17, wherein the at least one channel comprises a unidirectional channel configured to transmit a packet in one direction.

19. The system of claim 17, wherein the at least one channel comprises a bidirectional channel configured to transmit a packet in a first direction or a second direction opposite to the first direction.
